(19) United States
(12) Patent Application Publication
(10) Pub. No.: US 2021/0176248 A1
(43) Pub. Date: Jun. 10, 2021

(54) METHOD FOR SECURELY CONNECTING A WATCH TO A REMOTE SERVER

(71) Applicant: Tissot SA, Le Locle (CH)

(72) Inventor: Edoardo FRANZI, Cheseaux-Noreaz (CH)

(73) Assignee: Tissot SA, Le Locle (CH)

(21) Appl. No.: 17/092,631

(22) Filed: Nov. 9, 2020

(30) Foreign Application Priority Data
Dec. 6, 2019 (EP) 19214190.1

(51) Int. Cl. H04L 29/06; H04L 29/08

(52) U.S. Cl. CPC H04L 63/0876; H04L 67/141

(57) ABSTRACT

A method for securely connecting a watch to a remote server of a service provider including: authenticating the wearer of the watch authorising access to use the functions of this watch; selecting one of said functions from an input interface of said watch aiming at establishing a connection between said watch and the remote server; identifying the wearer of the watch from an interaction between the wearer of this watch and a graphic representation comprised in said watch; transmitting to said remote server an authentication element relating to the selected function once the wearer is identified, and carrying out an authentication of the wearer by the remote server from said authentication element in order to authorise an exchange of data between the watch and this remote server.

### CROSS-REFERENCE TO RELATED APPLICATIONS

This application claims priority to European Patent Application No. 19214190.1 filed Dec. 6, 2019, the entire contents of which are incorporated by reference.

### TECHNICAL FIELD

The present invention relates to a method for securely connecting a watch to a remote server and to a system implementing such a method.

The invention also relates to a computer program.

### PRIOR ART

A watch comprises a set of functions that can be used by the wearer. Such functions can allow access to remote servers implementing service provisions such as banking provisions, commercial provisions (online shops, e-commerce companies), electronic messaging or instant messaging provisions. In such a context, the wearer of the watch must manage and store an increasing number of identifiers, passwords and access codes which are authentication elements. Such authentication elements are often to be worn by the wearer when he must initiate a connection to a remote server in order to benefit from a service provision. For this purpose, it is common that the wearer, failing to memorise all these confidential data, prefers to group them together on paper or else in a standard computer file of the spreadsheet type archived on media allowing the storage of digital data, whether hard disks, flash memory, a USB key, etc. This situation has the disadvantage that the documents/files containing these authentication elements can be stored in an environment with little or no protection. This introduces a significant security flaw in the management of authentication elements.

Under these conditions, it is understood that there is a need to find an alternative solution, in particular which does not have the disadvantages of the prior art.

### SUMMARY OF THE INVENTION

A purpose of the present invention is therefore to provide a method for securely connecting a watch to a remote server which is reliable and robust.

To this end, the method for securely connecting a watch to a remote server of a service provider including the following steps:
authenticating the wearer of the watch authorising access to use the functions of this watch, and
selecting one of said functions from an input interface of said watch aiming at establishing a connection between said watch and the remote server;
identifying the wearer of the watch from an interaction between the wearer of this watch and a graphic representation comprised in said watch;
transmitting to the remote server an authentication element relating to the selected function once the wearer is identified, and
carrying out an authentication of the wearer by the remote server from said authentication element in order to authorise an exchange of data between the watch and this remote server.

In other embodiments:
the transmission step comprises a sub-step of selecting the authentication element relating to said selected function in anticipation of its sending to the remote server, among the authentication elements archived in the memory elements of the processing unit of the watch;
the step of carrying out an authentication comprises a sub-step of comparison between the authentication element received from the watch and a reference authentication element archived in the server;
the identification step comprises a sub-step of presenting a graphic representation on an interface for broadcasting a visual piece of information of said watch;
the presentation sub-step comprises a phase of generating the display of the graphic representation on the interface for broadcasting a visual piece of information;
the presentation sub-step comprises a phase of triggering a countdown as soon as the generation phase is carried out;
the identification step comprises a sub-step of selecting within a limited time interval a sequence of at least two identification portions comprised in said graphic representation aiming at identifying said wearer, said sequence corresponding to an identification code of the wearer;
the identification step comprises a sub-step of validating the selected sequence;
the validation sub-step comprises a phase of controlling that the selection of the sequence of identification portions has been carried out within the limited time interval defined by a countdown.

The invention also relates to a system for securely connecting a watch to a remote server implementing this method, the watch comprising the following elements connected together: a processing unit, an input interface, an interface for broadcasting a visual piece of information and a wireless communication interface for data exchanges with said remote server.

The invention also relates to a computer program comprising program code instructions for executing the steps of the method when said program is executed by the processing units of a watch and of a remote server.

### BRIEF DESCRIPTION OF THE FIGURES

Other features and advantages will emerge clearly from the description which is given below, in an indicative and non-limiting manner, with reference to the appended figures, wherein:

FIG. 1 is a schematic representation of a system for securely connecting a watch to a remote server, according to one embodiment of the invention, and

FIG. 2 is a flowchart relating to a method for securely connecting the watch to the remote server, according to the embodiment of the invention.

### DETAILED DESCRIPTION OF THE INVENTION

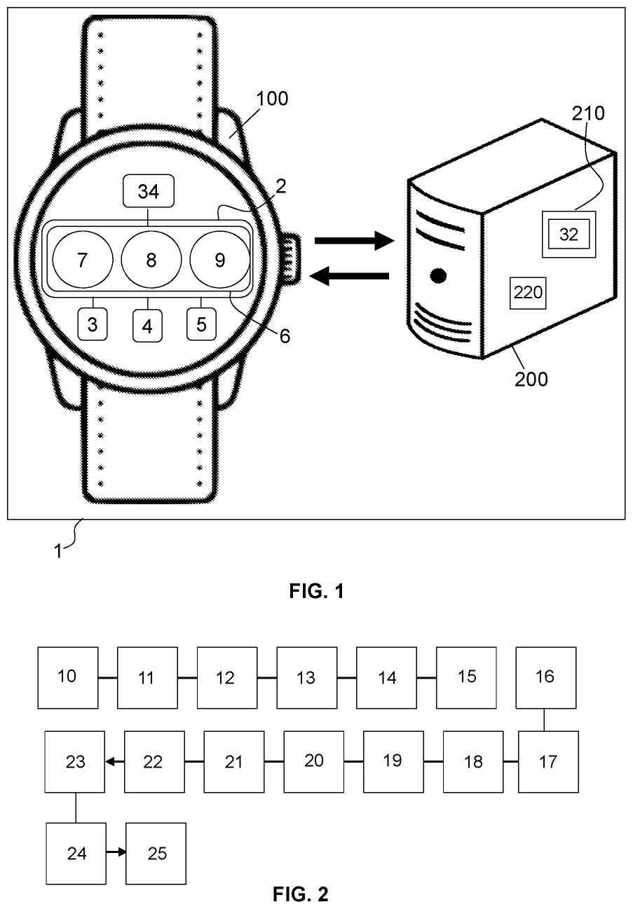

FIG. 1 shows a system 1 for securely connecting a watch to a remote server 200. In this system 1, the watch 100 is preferably a mechanical watch 100 connected to a hybrid display. In this context, the watch 100 comprises a body such as a watch case, and an attachment element such as a wristlet allowing this body to be fastened, for example to the wrist of the wearer. This watch 100 more specifically comprises in a non-limiting and/or non-exhaustive manner:
a processing unit 2 including hardware and software resources, in particular at least one processor cooperating with memory elements 6;
an interface for broadcasting a visual piece of information 3 such as a hybrid display dial provided with a first analogue display component and a second digital and/or alphanumeric display component;
an interface for broadcasting an audio piece of information 4 such as a loudspeaker;
a wireless communication interface 5 (for example cellular, WLAN Bluetooth, etc.), and
an input interface 34 such as a keyboard or even a touch interface comprised for example in the interface for broadcasting a visual piece of information 3.

In this watch 100, the processing unit 2 is connected, among others, to the interfaces for broadcasting a visual and sound piece of information 3, 4, to the input interface 34 and the wireless communication interface 5.

In this system 1, the server 200 comprises a processing unit 210 and a communication interface 220. This server 200 is a remote server of a service provider, for example a server of a banking or commercial service provider (online shops, e-commerce companies), electronic messaging or instant messaging provisions. In this context, the processing unit 210 of this server 200 comprises memory elements including a reference authentication element 32. This reference authentication element 32 is capable of participating in the creation of a secure connection between the remote server 200 and said watch 100 and can comprise keys, certificates, authentication codes, passwords and personal codes, etc.

In this watch, the memory elements 6 of the processing unit 2 of the watch 100 comprise data relating to authentication elements 9 specific to each remote server 200 to which the watch 100 is connected. In other words, these authentication elements 9 are specific to the wearer and/or to the watch 100, and thus allow the wearer to connect to the server 200 he wishes by means of a selection of a function of the watch 100.

These memory elements 6 of the processing unit 2 also comprise at least one graphic representation 7 allowing the wearer to be identified, as will be seen below. This graphic representation 7 can for example be an image comprising at least one object. By way of example, this image defines a scene comprising a plurality of objects such as houses, vehicles and/or a star such as the moon, etc. It is obviously understood that this image can define other types of scenes including at least one object. These memory elements 6 also include data relating to a reference sequence 8 comprising reference identification portions of this graphic representation 7, said portions having been previously selected by the wearer of the watch 100 during a configuration process relating to the identification of the wearer.

The system 1 is capable of implementing a method for secure connection to the remote server 200 of a service provider, shown in FIG. 2. Such a server 200 of a service provider can be for example a server of banking or commercial service provider (online shops, e-commerce companies), electronic messaging or instant messaging provisions.

This method comprises a step 10 of authenticating the wearer of the watch 100 authorising access to use the functions of this watch 100. This authentication step 10 therefore allows the wearer of the watch to be identified with certainty so that he can have access to use all the functions of this watch 100. In other words, it allows the wearer to provide proof of his identity by providing for the input of an authentication code or a secret code by means of an interaction between the wearer and the input interface 34.

In addition, it is understood that the functions can be implemented by computer programs executed by the processing unit 2 of the watch 100 as soon as these programs are activated/selected following an interaction between the wearer and the input interface 34 of this watch 100. These computer programs thus executed allow the wearer to benefit from service provisions, for example of the banking, commercial type or else instantaneous or electronic messaging.

Following this authentication step 10, the method comprises a step 11 of selecting one of said functions from the input interface 34 of said watch 100 aiming at establishing a connection between said watch 100 and the remote server 200. It will be understood that the functions can be implemented by computer programs executed by the processing unit 2 of the watch 100 as soon as these functions which are displayed on/in the interface for broadcasting a visual piece of information 3, are activated/selected after an interaction between the wearer and the input interface 34 of this watch 100. These computer programs thus executed allow the wearer to benefit from service provisions for example of the banking, commercial or else instant or electronic messaging.

The method then comprises a step 12 of identifying the wearer of the watch 100 from an interaction between the wearer of this watch and a graphic representation comprised in said watch 100 more particularly a graphic representation displayed on/in the interface for broadcasting a visual piece of information 3 of said watch 100. Such a step 12 is carried out systematically following the selection of a function in order, in particular, to allow the processing unit 2 to control that the wearer of the watch 100 is still in possession of the latter and that he is indeed at the origin of the selection of the function. This step 12 comprises a sub-step 13 of presenting a graphic representation 7 on/in the interface for broadcasting a visual piece of information 3 of said watch 100. This sub-step 13 includes a phase 14 of generating the display, on/in the interface for broadcasting a visual piece of information 3, of the graphic representation 7 provided for the implementation of this identification. This phase 14 may comprise a sub-phase of selecting by the wearer from a sample of at least two graphic representations 7 displayed on the interface for broadcasting a visual piece of information 3, the graphic representation 7 provided for the implementation of this identification. It will be noted that the wearer is the only one who knows the graphic representation 7 that he has chosen when configuring the process relating to this identification.

This presentation sub-step 13 then comprises a phase 15 of triggering a countdown as soon as the generation phase 14 is carried out. In other words, the preconfigurable countdown is triggered once the graphic representation 7 is presented on the broadcast interface 3. Such a phase 15 participates from a limited time interval defined by this countdown, in counting the estimated time required for the input of the sequence of identification portions of the graphic representation 7 displayed on/in on the broadcast interface 3.

Subsequently, the identification step 12 comprises a sub-step 16 of selecting within the limited time interval a sequence of at least two identification portions of said graphic representation 7 aiming at identifying said wearer, said sequence corresponding to an identification code of the wearer. Such identification portions are not directly visible in the graphic representation 7 presented on/in the broadcast interface 3. Under these conditions, the selection sub-step 16 comprises a phase 17 of visualising at least one of said identification portions of the sequence in said graphic representation 7. This visualisation phase 17 comprises a sub-phase of selecting at least one area of interest of the graphic representation 7 capable of comprising said at least one identification portion. During this sub-phase, the wearer selects for example a first area of interest or a second area of interest by carrying out an enlargement of this first area or this second area from the input interface 35. Once this first or second area of interest is selected, the identification portions then become visible. In this configuration, each identification portion useful for performing/constituting the sequence can be selected from the input interface 35.

It should be noted that the sequence comprises an ordered number of identification portions and that the selected area of interest may comprise, for example, three identification portions only two of which are ordered successively one after the other in the sequence. In this context, the remaining identification portion requires in order to be part of the sequence, the selection of an identification portion comprised in another area of interest of the graphic representation 7.

Then, the identification step 12 comprises a sub-step 18 of validating the selected sequence. This validation sub-step 18 comprises a phase 19 of controlling that the selection of the sequence of identification portions has been carried out within the limited time interval defined by the countdown. Insofar as this selection was not carried out within the limited time interval, the validation sub-step 18 comprises a phase 20 of renewing the presentation 13 and selection 16 sub-steps. If subsequently, the selection of the sequence has not been carried out again within the limited time interval, the establishment of the connection to the remote server is suspended or even removed. In addition, access to the watch 100 is also removed and in particular access to the functions of this watch 100. In this context, the wearer of the watch is invited to authenticate himself again in order to provide proof of his identity by inputting an authentication code or a secret code, by means of an interaction between the wearer and the input interface 34.

Insofar as this selection has been made within this limited time interval, the validation sub-step 18 then comprises a comparison phase 21, implemented by the processing unit 2, between said selected sequence and the reference sequence 8. This comparison phase 21 comprises a sub-phase of rejecting the identification of the wearer if said sequence is substantially different or different from the reference sequence 8. In this case, the establishment of the connection to the remote server is suspended or even removed. In addition, access to the watch 100 is also removed and in particular the access to the functions of this watch 100. In this context, the wearer of the watch is invited to authenticate himself again in order to provide proof of his identity by inputting an authentication code or a secret code, by means of an interaction between the wearer and the input interface 34. Indeed, the wearer and owner of the watch 100 may no longer be in possession thereof.

Conversely, the comparison phase 21 also comprises a sub-phase of successfully identifying the wearer if said sequence is substantially similar or similar to the reference sequence 8. In this case, the method then provides for the implementation of a step 22 of transmitting to said remote server 200 the authentication element relating to the selected function once the wearer is identified, said authentication element being specifically defined to participate in an authentication of the wearer with the remote server 200. This step 22 comprises a sub-step 23 of selecting the authentication element relating to said selected function in anticipation of its sending to the remote server 200. During this sub-step 23, the selected function is identified, and on the on the basis of this identification, a selection of the authentication element is carried out from the authentication elements archived in the memory elements 6 of the processing unit 2 of the watch 100. As already mentioned previously, the authentication elements 9 may be keys, certificates, authentication codes, passwords and personal codes which are each dedicated to the authentication of the wearer of the watch 200 to the corresponding service provider and therefore to the remote server comprised in a technical platform of this provider. It is understood here that the authentication element is dedicated to authenticating the wearer to a remote server of a given service provider. In addition, the authentication elements are archived in the memory elements 6 of the processing unit 2 of the watch 100, each being associated with a digital identification element of a corresponding function.

The method then comprises a step of performing an authentication 24 of the wearer by the remote server 200 from said authentication element in order to authorise an exchange of data between the watch 100 and this remote server 200. In this context, it is understood that this data exchange which is authorised here corresponds to the data exchanged between the watch 100 and the server 200 in the context of the provision of a service from which the wearer can benefit as soon as he is authenticated with the remote server 200 therefore with the service provider. Such a step 24 comprises a comparison sub-step 25, carried out by the processing unit 210 of the server 200, between the authentication element received from the watch and a reference authentication element 32 archived in the server 200. This comparison sub-step 25 comprises a phase of rejecting the identification of the wearer 22 if the authentication element is substantially different or different from the reference authentication element 32. In this case, the establishment of the connection to the remote server 200 is suspended or even removed.

The comparison sub-step 25 also comprises a phase of successfully identifying the wearer if the authentication element is substantially similar or similar to the reference authentication element 32. In this context, an exchange of data between the watch 100 and this remote server 200 in connection with the service provision is then authorised.

Thus, the invention allows the wearer and owner of the watch 200 to be able to be authenticated with all the remote servers of the service providers based on only his identification from an interaction between the wearer of this watch and a graphic representation comprised in said watch 100, without having to directly enter the authentication element specific to each of these servers 200 in order to be able to authenticate himself to the corresponding service provider.

The invention also relates to a computer program comprising program code instructions for executing steps 10 to 25 of this method when said program is executed by the processing unit 2 of the watch 100.

1. A method for securely connecting a watch (100) to a remote server (200) of a service provider including the following steps:
authenticating (10) the wearer of the watch (100) authorising access to use the functions of this watch (100), and
selecting (11) one of said functions from an input interface of said watch aiming at establishing a connection between said watch (100) and the remote server (200);
identifying (12) the wearer of the watch (100) from an interaction between the wearer of this watch and a graphic representation comprised in said watch (100);
transmitting (22) to said remote server (200) an authentication element relating to the selected function once the wearer is identified, and
carrying out an authentication (24) of the wearer by the remote server (200) from said authentication element in order to authorise an exchange of data between the watch (100) and this remote server (200).

2. The method according to claim 1, wherein the transmission step (22) comprises a sub-step (23) of selecting the authentication element relating to said selected function in anticipation of its sending to the remote server (200), among the authentication elements archived in the memory elements (6) of the processing unit (2) of the watch (100).

3. The method according to claim 1, wherein the step of carrying out an authentication (24) comprises a sub-step (25) of comparison between the authentication element received from the watch (100) and a reference authentication element (32) archived in the server (200).

4. The method according to claim 1, wherein the identification step (12) comprises a sub-step (13) of presenting a graphic representation (7) on an interface for broadcasting a visual piece of information (3) of said watch (100).

5. The method according to claim 1, wherein the presentation sub-step (13) comprises a phase (14) of generating the display of the graphic representation (7) on the interface for broadcasting a visual piece of information (3).

6. The method according to claim 1, wherein the presentation sub-step (13) comprises a phase (15) of triggering a countdown as soon as the generation phase (14) is carried out.

7. The method according to claim 1, wherein the identification step (12) comprises a sub-step (16) of selecting within a limited time interval a sequence of at least two identification portions comprised in said graphic representation (7) aiming at identifying said wearer, said sequence corresponding to an identification code of the wearer.

8. The method according to claim 1, wherein, the identification step (12) comprises a sub-step (18) of validating the selected sequence.

9. The method according to claim 1, wherein the validation sub-step (18) comprises a phase of controlling (19) that the selection of the sequence of identification portions has been carried out within the limited time interval defined by a countdown.

10. A system (1) for securely connecting a watch (100) to a remote server implementing the method according to claim 1, the watch (100) comprising the following elements connected together: a processing unit (2), an input interface (34), an interface for broadcasting a visual piece of information (3) and a wireless communication interface for data exchanges with said remote server (200).

11. A computer program comprising program code instructions for executing steps (10 to 25) of the method according to claim 1 when said program is executed by the processing units (2) of a watch (100) and of a remote server (200).
